(19) United States
(12) Patent Application Publication
(10) Pub. No.: US 2007/0226520 A1
(43) Pub. Date: Sep. 27, 2007

(54) Information Recording Medium, Information Recording Device and Method, Information Distribution Device and Method, and Computer Program

(76) Inventor: Kazuo Kuroda, Saitama (JP)

Correspondence Address: YOUNG & THOMPSON, 745 SOUTH 23RD STREET, 2ND FLOOR, ARLINGTON, VA, 22202, US

(21) Appl. No.: 11/631,516

(22) PCT Filed: Jul. 4, 2005
(86) PCT No.: PCT/JP05/12334

§ 371 Date: Mar. 5, 2007

(30) Foreign Application Priority Data
Jul. 7, 2004 (JP) 2004-200433

(51) Int. Cl. G11B 20/10; G06F 12/14; G11B 20/12

(52) U.S. Cl. 713/193

(57) ABSTRACT

An information recording device (300) transmits first area information (510) from an information recording medium (100) to an information distribution device (200). The information distribution device acquires an encryption key from the first area information transmitted from the information recording device and encrypts the recorded information (content). The information distribution device distributes the encrypted recorded information (encrypted content) and second area information (520) corresponding to the first area information to the information recording device. When the first area information coincides with the second area information, the information recording device records the distributed encrypted recorded information and the second area information on the information recording medium.

### TECHNICAL FIELD

The present invention relates to an information recording medium, such as a DVD, an information recording apparatus and an information recording method, such as a DVD recorder, an information distributing apparatus for and an information distributing method of distributing or delivering contents to the information recording apparatus or the like, and a computer program which makes a computer function as the information recording apparatus and the information distributing apparatus or the like, for example.

### BACKGROUND ART

A large-volume recording medium, such as a DVD, has been spread, and even at home, there is an improved environment in which movie contents or the like can be readily watched through a network. Moreover, such a style has been also spread that the movie contents or the like are obtained through the network and that the obtained movie contents are recorded onto the DVD or the like and watched.

In this case, in order to protect the copyright of the movie contents, the distributed movie contents or the like are generally encrypted. This encryption is performed in accordance with an encryption system described in a non-patent document 1, for example. As a more specific method of distributing the movie contents or the like, as described in a patent document 1 or the like, for example, there is suggested a distribution system for recording an encryption key used for an encryption process in advance on a record-type DVD or the like, such as a DVD-R/RW, selling it, and distributing the encrypted movie contents through the network.

In addition, there are also suggested various encryption methods (or content distribution system), as described in patent documents 2 and 3. The encryption methods prevent the illegal copy of the movie contents or the like in the middle of the distribution, and at the same time, the methods also lead to the protection of the copyright of the movie contents.
Patent document 1: Japanese Patent Application Laid Open NO. 2001-307427
Patent document 2: Japanese Patent Application Laid Open NO. 2001-357001
Patent document 3: Japanese Patent Application Laid Open NO. 2000-331412
Patent document 4: Japanese Patent Application Laid Open NO. Hei 11-110914
Non-patent document 1: “Protection of DVD contents”, Toshiba review, Vol. 58, No. 6, p 28-p 31, 2003

### DISCLOSURE OF INVENTION

Subject to be Solved by the Invention

However, on the record type information recording medium, such as the record type DVD, regional information can be reproduced in all regions, wherein the regional information indicates an allowed region in which recording or reproduction is allowed, including a region code (regional code). Thus, in the case of an illegal record type information recording medium on which not only the record information, such as the movie contents, but also encryption information including an encryption key or the like are copied, there is such a technical problem that the copyright of the record information is not protected, which allows illegal reproduction.

It is therefore an object of the present invention to provide an information recording medium, an information recording apparatus, an information recording method, an information distributing apparatus, and an information distributing method, which can distribute the contents or the like while maintaining high confidentiality, and a computer program which makes a computer function as the information recording apparatus and the information distributing apparatus.

Means for Solving the Subject

(Information Recording Medium)

The above object of the present invention can be achieved by an information recording medium provided with: an encryption key recording area in which an encryption key for encrypting record information is recorded in advance; a regional information recording area in which first regional information is recorded in advance, the first regional information indicating an allowed region in which recording or reproduction of encrypted record information encrypted on the basis of the encryption key, is allowed; and an information recording area to record therein (i) the encrypted record information and (ii) second regional information indicating an allowed region in which recording or reproduction of the encrypted record information, is allowed.

According to the information recording medium of the present invention, the encryption key is recorded in advance in the encryption key recording area, such as a control data zone, for example. Moreover, in the information recording area, such as a data recording area, for example, an information recording apparatus described later can record the encrypted record information obtained by encrypting the record information, such as predetermined movie contents, for example, which is distributed from an information distributing apparatus described later and which is downloaded, by using the encryption key. Incidentally, with regard to the encryption key held by the information recording medium, the information distributing apparatus described later can desirably specify the encryption key by some means or by using a distribution system. For example, it may be constructed such that the encryption key may be specified through identification information described later.

Particularly in the present invention, the first regional information is recorded in advance in the regional information recording area, wherein the first regional information indicates the allowed area in which the recording or reproduction of the encrypted record information is allowed. More specifically, the first region information is information indicating allowance or nonallowance of the recording or reproduction of the record information, such as movie content data, for example, in accordance with each region code, wherein the earth is divided into six regions, for example, and the region codes (RC: region identification number) of “#1” to “#6” are allocated to the respective regions. Moreover, in the information recording area, it is possible to record the second regional information indicating the allowed area in which the recording or reproduction of the encrypted record information is allowed, in addition to the encrypted record information distributed, wherein the both information are distributed by the information distributing apparatus described later.

The first regional information and the second regional information match under a legal distribution system. The term “match” not only means that information expressed by numerical numbers, such as bit data, for example, is completely equivalent or equal, but also includes the case where it is defined to be equivalent or equal in accordance with a predetermined rule. On the other hand, the first regional information and the second regional information do not match under an illegal distribution system.

Consequently, it is not until satisfying such a condition that the first regional information held by the information recording medium matches the second regional information appended to the record information, such as movie contents, by the information distributing apparatus described later, that the information recoding apparatus can record or reproduce the record information. Incidentally, it is desirable to encrypt the record information and distribute it as the encrypted record information, in order to increase the secrecy and confidentiality of the distribution system. Moreover, in the same manner, it is also desirable to encrypt the second regional information and distribute it as the encrypted regional information.

If the first regional information is not recorded in advance on the record type information recording medium, such as a record type DVD, for example, only the encryption system realized by the encryption key is relied on. Thus, in the case of an illegal record type information recording medium on which not only the record information, such as movie contents, but also the encryption key are copied by some means, the copyright of the record information is not protected, which allows illegal recording or reproduction.

In contrast, according to the present invention, it is required to satisfy such a condition that the first regional information recorded in advance on the information recording medium matches the second regional information corresponding to the distributed record information, as a result of the comparison performed by a comparing device of the information recording apparatus described later, for example. Thus, it is possible to further increase the secrecy and confidentiality of the distribution system, to thereby almost or completely prevent the illegal recording or reproduction of the record information.

In addition, according to the present invention, it is possible to impose regional restrictions by using the first regional information. More specifically, it is possible to realize the regional restrictions without depending on standard television methods adopted by countries, in a region with a region code of #2, for example, wherein Europe, such as England and France, Middle East, such as Jordan, whose broadcast system is PAL, and Japan, whose broadcast is NTSC are mixed. Moreover, it is possible to realize the regional restrictions depending on different doctrines and different values, by allocating China of the communist block as a particular region with a region code of #6. Moreover, a supplier of movie contents, such as the Hollywood movie industry, can manage the order of distributing a movie, i.e. the order of releasing a movie in each region.

Incidentally, in the present invention, the encryption key is used for the encryption of the record information; however, the encryption by the encryption key may be the encryption of the record information directly using the encryption key, or the encryption of the record information indirectly using the encryption key (e.g. such construction that the encryption of the record information is performed by using another key, and that the key, which is used for the encryption of the record information, is encrypted by using the encryption key recorded in the encryption key recording area). In short, any key somehow contributing to the encryption of the record information corresponds to the “encryption key” of the present invention.

In one aspect of the information recording medium of the present invention, the second regional information (i) is encrypted on the basis of the encryption key and (ii) is recorded in the information recording area as encrypted regional information with the encrypted record information.

According to this aspect, by that the second regional information is encrypted by the information distributing apparatus described later, it is possible to improve the confidentiality in the distribution or the like of the encrypted regional information, to thereby preferably protect the copyright of the contents.

In one aspect of the information recording medium of the present invention, it is further provided with an identification information recording area in which identification information for identifying the information recording medium, is recorded in advance.

According to this aspect, it is possible to preferably record the encrypted record information which is distributed or the like after the encryption (e.g. encrypted contents described later), into the information recording area. Moreover, as described later, it is possible to distribute or the like the record information (contents) while maintaining the higher confidentiality, by transmitting the identification information to be recorded into the identification information recording area, from the information recording apparatus to the information distributing apparatus.

In an aspect associated with the identification information, the identification information may be information peculiar to the information recording medium.

By virtue of such construction, it is possible to properly and certainly recognize the encryption key recorded on the information recording medium, from the identification information.

(Information Recording Apparatus)

The above object of the present invention can be also achieved by an information recording apparatus for recording the encrypted record information and the second regional information onto the above-mentioned information recording medium of the present invention (including its various aspects, the information recording apparatus provided with: a transmitting device for transmitting the first regional information to an information distributing apparatus for distributing the encrypted record information and the second regional information; a receiving device for receiving the encrypted record information and the second regional information distributed from the information distributing apparatus; and a recording device for recording the received encrypted record information and the received second regional information into the information recording area.

According to the information recording apparatus of the present invention, by the operation of the recording device, it is possible to record the encrypted record information distributed from the information distributing apparatus (e.g. the information distributing apparatus of the present invention described later), into the information recording area.

Particularly in the present invention, in order to encrypt the record information, the identification information described later in addition to the first regional information recorded on the information recording medium is transmitted to the information distributing apparatus, by the operation of the transmitting device. Namely, it is not the encryption key recorded in advance on the information recording medium that is directly transmitted, but the identification information in addition to the first regional information which can specify the encryption key yet which itself is open information (i.e. which does not require high confidentiality) that is transmitted. Then, the record information which is encrypted (i.e. the encrypted record information) is distributed by the information distributing apparatus to the information recording apparatus, and recorded onto the information recording medium.

At this time, even if the transmitted identification information in addition to the transmitted first regional information is browsed by a malicious third party, the identification information itself in addition to the first regional information is originally open information, so that the third party cannot recognize the encryption method (e.g. the encryption key, etc.) by using this. Therefore, even if the encrypted record information is browsed by the malicious third party at the distribution stage, the third party cannot decode the encrypted record information. If not the identification information in addition to the first regional information, but the encryption key, which itself indicates the encryption method, is directly transmitted from the information recording apparatus to the information distributing apparatus, there is a possibility that the malicious third party obtains the encryption key. As a result, there is also considered such a disadvantage that the illegally obtained encrypted record information is decoded. However, in the present invention, the identification information in addition to the first regional information, which itself is originally open information, is transmitted as described above, such a disadvantage can be preferably prevented. Therefore, there is such a great advantage that it is possible to greatly improve (or increase) the confidentiality in the content distribution. Namely, it is possible to distribute the record information under a more secure environment.

Consequently, according to the information recording apparatus of the present invention, it is possible to improve the confidentiality in the content distribution or the like, to thereby preferably protect the copyright of the contents.

Incidentally, in response to the various aspects owned by the above-mentioned information recording medium of the present invention, the information recording apparatus of the present invention can also adopt various aspects.

In one aspect of the information recording apparatus of the present invention, the information recording medium is further provided with an identification information recording area in which identification information for identifying the information recording medium is recorded in advance, the transmitting device further transmits the identification information to the information distributing apparatus, the receiving device receives (i) the encrypted record information encrypted on the basis of the encryption key corresponding to the first regional information and the identification information, and (ii) encrypted regional information obtained by encrypting the second regional information on the basis of the encryption key, and the recording device records the received encrypted record information and the received encrypted regional information.

According to this aspect, the identification information, which is more open information recorded on the information recording medium, is transmitted to the information distributing apparatus by the operation of the transmitting device, in order to encrypt the record information.

As a result, it is possible to further improve the confidentiality in the content distribution or the like, to thereby preferably protect the copyright of the contents.

In an aspect associated with the transmitting device, the transmitting device may (i) encrypt at least one of the identification information and the first regional information and (ii) transmit it to the information distributing apparatus.

By virtue of such construction, it is possible to protect at least one of the identification information and the first regional information from being browsed by the malicious third party, to thereby further increase the confidentiality of the information which is exchanged between the information recording apparatus and the information distributing apparatus.

In another aspect of the information recording apparatus of the present invention, it is further provided with a first comparing device for comparing (i) an allowed region indicated by the first regional information and (ii) an allowed region indicated by the second regional information, the recording device recording the received encrypted record information and the received second regional information into the information recording area, if the allowed region indicated by the first regional information and the allowed region indicated by the second regional information match on the basis of a result of the comparison performed by the first comparing device.

According to this aspect, the first comparing device of the information recording apparatus compares whether or not the first regional information held by the information recording medium matches the second regional information appended to the record information, such as movie contents, by the information distributing apparatus described later. It is not until satisfying such a condition that the first regional information matches the second regional information, that the information recording apparatus records or reproduces the record information. Incidentally, it is desirable to encrypt the record information and distribute it as the encrypted record information, in order to increase the secrecy and confidentiality of the distribution system. Moreover, in the same manner, it is also desirable to encrypt the second regional information and distribute it as the encrypted regional information.

As a result, it is possible to further increase the secrecy and confidentiality of the distribution system, together with the encryption system, to thereby almost or completely prevent the illegal recording or reproduction of the record information.

In addition, a supplier of movie contents, such as the Hollywood movie industry, can manage the order of distributing a movie, i.e. the order of releasing a movie in each region, more strictly, in cooperation with a manufacturer of the information recording medium.

In another aspect of the information recording apparatus of the present invention, it is further provided with a second comparing device for comparing (i) an allowed region indicated by the first regional information, (ii) an allowed region indicated by the second regional information and (iii) an allowed region indicated by third region information held as attribute information by the information recording apparatus, the recording device recording the received encrypted record information and the received second regional information into the information recording area, if (i-a) the allowed region indicated by the first regional information, (ii-a) the allowed region indicated by the second regional information and (iii-a) the allowed region indicated by the third regional information match on the basis of a result of the comparison performed by the second comparing device.

According to this aspect, the second comparing device of the information recording apparatus compares whether or not the first regional information held by the information recording medium, the second regional information appended to the record information, such as movie contents, by the information distributing apparatus described later, and the third regional information held as the attribute information by the information recording apparatus match. It is not until satisfying such a condition that the first regional information, the second regional information, and the third regional information match, that the information recording apparatus records or reproduces the record information.

As a result, it is possible to further increase the secrecy and confidentiality of the distribution system, together with the encryption system, to thereby almost or completely prevent the illegal recording or reproduction of the record information.

In addition, a supplier of movie contents, such as the Hollywood movie industry, can manage the order of distributing a movie, i.e. the order of releasing a movie in each region, more strictly, in cooperation with a manufacturer of the information recording medium and a manufacturer of the information recording apparatus, such as a DVD recorder.

In another aspect of the information recording apparatus of the present invention, the recording device disables the encrypted record information and the second regional information, if the recording of the encrypted record information and the second regional information into the information recording area does not succeed.

According to this aspect, if only one portion of the encrypted record information and one portion of the second regional information can be recorded onto the information recording medium, for example, it is possible to disable the encrypted record information and the second regional information. Thus, if the distribution of the encrypted record information and the second regional information is not certainly completed, the encrypted record information and the second regional information cannot be used (e.g. reproduced nor watched), so that it is possible to prevent such a disadvantage that the encrypted record information and the second regional information are illegally used. Therefore, it is possible to further increase the confidentiality in the content distribution.

Incidentally, as the case where the recording does not succeed, there are listed a case where the encrypted record information and the second regional information cannot be normally distributed or received, a case where the recording of the encrypted record information and the second regional information is only partially completed, and the like.

In an aspect associated with the recording device, the recording device may not record a file system or may not record a proper file system (i.e. in which preferable reproduction is ensured), as a way of the disabling.

By virtue of such construction, by not daringly recording the file system information, which is usually necessary to reproduce the record information, it is possible to disable the encrypted record information whose recording does not succeed, relatively easily. Moreover, by not daringly recording the proper (legal) file system according to the standard (or by recording an illegal file system which does not comply with the standard), it is possible to disable the encrypted record information whose recording does not succeed, relatively easily. In short, if the legal file system necessary for the reproduction operation is not recorded together with the encrypted record information, it is possible to relatively easily disable the encrypted record information.

In an aspect associated with the recording device, the recording device may overwrite an encrypted information portion, as a way of the disabling.

By virtue of such construction, it is possible to relatively easily disable the encrypted record information, to thereby further increase the confidentiality in the content distribution, as described above.

In another aspect of the information recording apparatus of the present invention, it is further provided with a result information transmitting device for transmitting result information to the information distributing apparatus, the result information indicating whether or not the recording of the encrypted record information into the information recording area succeeds.

According to this aspect, even on the information distributing apparatus side, it is possible to judge whether or not the recording of the encrypted information is normally performed, on the basis of the transmitted result information. Therefore, if the recording of the encrypted information is not normally performed, it is possible to distribute the encrypted record information again, for example, and it is possible to realize the more stable or certain content distribution.

(Information Recording Method)

The above object of the present invention can be also achieved by an information recording method of recording the encrypted record information and the second regional information onto the above-mentioned information recording medium of the present invention (including its various aspects), the information recording method provided with: a transmitting process of transmitting the first regional information to an information distributing apparatus for distributing the encrypted record information and the second regional information; a receiving process of receiving the encrypted record information and the second regional information distributed from the information distributing apparatus; and a recording process of recording the received encrypted record information and the received second regional information into the information recording area.

According to the information recording method of the present invention, it is possible to receive the various benefits owned by the above-mentioned information recording apparatus of the present invention.

Incidentally, in response to the various aspects owned by the above-mentioned information recording apparatus of the present invention, the information recording method of the present invention can also adopt various aspects.

(Information Distributing Apparatus)

The above object of the present invention can be also achieved by an information distributing apparatus for distributing the second regional information and the encrypted record information to the above-mentioned information recording apparatus of the present invention (including its various aspects), the information distributing apparatus provided with: a first regional information receiving device for receiving the first regional information transmitted from the information recording apparatus; an encryption key obtaining device for obtaining the encryption key corresponding to the received first regional information; an encrypting device for (i) encrypting the record information on the basis of the obtained encryption key and (ii) generating the encrypted record information; and a distributing device for distributing the generated encrypted record information and the second regional information corresponding to the first regional information, to the information recording apparatus.

According to the information distributing apparatus of the present invention, the encryption key is obtained by using the first regional information transmitted by the information recording apparatus. Then, the encrypted record information, encrypted by using the encryption key, is distributed to the information recording apparatus. Simultaneously or in tandem with that, the second regional information corresponding to the first regional information is distributed. Incidentally, the second regional information may indicate the allowed area which matches the allowed area indicated by the first regional information.

Namely, without exchanging the encryption key itself which requires high confidentiality, by exchanging the first regional information which does not require high confidentiality that much (so to speak, open), it is possible to encrypt and distribute the record information, or the like. Therefore, as in the above-mentioned information recording apparatus, there is such a great advantage that it is possible to greatly improve (or increase) the confidentiality in the distribution of the record information, such as the contents.

Consequently, according to the information distributing apparatus of the present invention, it is possible to receive the same various benefits as those owned by the above-mentioned information recording apparatus of the present invention.

Incidentally, in response to the various aspects owned by the above-mentioned information recording medium or information recording apparatus of the present invention, the information distributing apparatus of the present invention can also adopt various aspects.

In one aspect of the information distributing apparatus of the present invention, the information recording medium is further provided with an identification information recording area in which identification information for identifying the information recording medium is recorded in advance, the information distributing apparatus is further provided with an identification information receiving device for receiving the identification information transmitted from the information recording apparatus, the encryption key obtaining device obtains the encryption key corresponding to the received identification information in addition to or instead of the first regional information, the encrypting device further encrypts the second regional information as encrypted regional information, on the basis of the obtained encryption key, and the distributing device further distributes the encrypted regional information.

According to this aspect, without exchanging the encryption key itself which requires high confidentiality, by exchanging the identification information in addition to or instead of the first regional information which does not require high confidentiality that much (so to speak, open), it is possible to encrypt and distribute the record information and the second regional information, or the like. Therefore, as in the above-mentioned information recording apparatus, there is such a great advantage that it is possible to greatly improve (or increase) the confidentiality in the distribution of the record information, such as the contents.

In an aspect associated with the encryption key, (i) the encryption key and (ii) at least one of the first regional information and the identification information may be associated in a relationship of N versus. M (wherein each of N and M is an integer of 1 or more).

By virtue of such construction, it is possible to randomly associate the encryption key and at least one of the first regional information and the identification information, to thereby further increase the confidentiality in the distribution of the record information.

In an aspect associated with the encryption key obtaining unit, the encryption key obtaining device may obtain the encryption key on the basis of at least one of a correspondence table and a function for defying an association between (i) the encryption key and (ii) at least one of the first regional information and the identification information.

By virtue of such construction, it is possible to relatively easily obtain the encryption key corresponding to at least one of the first regional information and the identification information, with reference to the correspondence table and the function or the like.

In another aspect of the information distributing apparatus of the present invention, attributes of the distributed second regional information and the distributed encrypted record information are “Never Copy” attributes.

According to this aspect, it is impossible to copy or duplicate, or reproduce the distributed second regional information the distributed encrypted information, until they are certainly recorded onto the preferable recording medium. Therefore, it is possible to further increase the confidentiality in the distribution of the record information.

In another aspect of the information distributing apparatus of the present invention, the encrypting device (i) encrypts the record information with a predetermined title key and (ii) encrypts the title key with the encryption key, to thereby generate the encrypted record information.

According to this aspect, as in the encryption system described in the non-patent document 1 described above, for example, it is possible to generate the encrypted record information, which includes the record information encrypted by using the title key and the title key encrypted by using the encryption key. Namely, the record information is more severely encrypted by using both the title key and the encryption key, so that it is possible to further increase the confidentiality in the distribution of the record information, and thus it is possible to preferably protect the copyright of the contents.

(Information Distributing Method)

The above object of the present invention can be also achieved by an information distributing method of distributing the second regional information and the encrypted record information to the above-mentioned information recording apparatus of the present invention (including its various aspects), the information distributing method provided with: a first regional information receiving process of receiving the first regional information transmitted from the information recording apparatus; an encryption key obtaining process of obtaining the encryption key corresponding to the received first regional information; an encrypting process of encrypting the record information on the basis of the obtained encryption key and generating the encrypted record information; and a distributing process of distributing the generated encrypted record information and the second regional information corresponding to the first regional information, to the information recording apparatus.

According to the information distributing method of the present invention, it is possible to receive the various benefits owned by the above-mentioned information distributing apparatus of the present invention.

Incidentally, in response to the various aspects owned by the above-mentioned information distributing apparatus of the present invention, the information distributing method of the present invention can also adopt various aspects.

(Computer Program)

The above object of the present invention can be also achieved by a first computer program of instructions for recording control and for tangibly embodying a program of instructions executable by a computer provided in the above-mentioned information recording apparatus of the present invention (including its various aspects), to make the computer function as at least one portion of the transmitting device, the receiving device, and the recording device.

The above object of the present invention can be also achieved by a second computer program of instructions for distribution control and for tangibly embodying a program of instructions executable by a computer provided in the above-mentioned information distributing apparatus according of the present invention (including its various aspects, to make the computer function as at least one portion of the first regional information receiving device, the encryption key obtaining device, the encrypting device, and the distributing device.

According to the first or second computer program of the present invention, the above-mentioned information recording apparatus or information distributing apparatus of the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the various aspects of the above-mentioned information recording apparatus or information distributing apparatus of the present invention, the first or second computer program of the present invention can also adopt various aspects.

(Computer Program Product)

The above object of the present invention can be also achieved by a first computer program product in a computer-readable medium for tangibly embodying a program of instructions executable by a computer provided in the above-mentioned information recording apparatus of the present invention (including its various aspects), to make the computer function as at least one portion of the transmitting device, the receiving device, and the recording device.

The above object of the present invention can be also achieved by a second computer program product in a computer-readable medium for tangibly embodying a program of instructions executable by a computer provided in the above-mentioned information distributing apparatus of the present invention (including its various aspects), to make the computer function as at least one portion of the first regional information receiving device, the encryption key obtaining device, the encrypting device, and the distributing device.

According to the first or second computer program product of the present invention, the above-mentioned information recording apparatus or information distributing apparatus of the present invention can be embodied relatively readily, by loading the computer program product from a recording medium for storing the computer program product, such as a ROM (Read Only Memory), a CD-ROM (Compact Disc—Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the above-mentioned information recording apparatus or information distributing apparatus of the present invention.

Incidentally, in response to the various aspects of the above-mentioned information recording apparatus or information distributing apparatus of the present invention, the first or second computer program product of the present invention can also adopt various aspects.

These effects and other advantages of the present invention will become more apparent from the following embodiments.

As explained above, the information recording medium of the present invention is provided with: the encryption key recording area; the regional information recording area; and the information recording area. Moreover, the information recording apparatus of the present invention is provided with: the transmitting device; the receiving device; and the recording device. The information recording method of the present invention is provided with: the transmitting process; the receiving process; and the recording process. Moreover, the information distributing apparatus of the present invention is provided with: the first regional information receiving device; the encryption key obtaining device; the encrypting device; and the distributing device. The information distributing method of the present invention is provided with: the first regional information receiving process; the encryption key obtaining process; the encrypting process; and the distributing process. Therefore, it is possible to further increase the secrecy and the confidentiality in the distribution system, and it is possible to almost or completely prevent the illegal recording of reproduction of the record information.

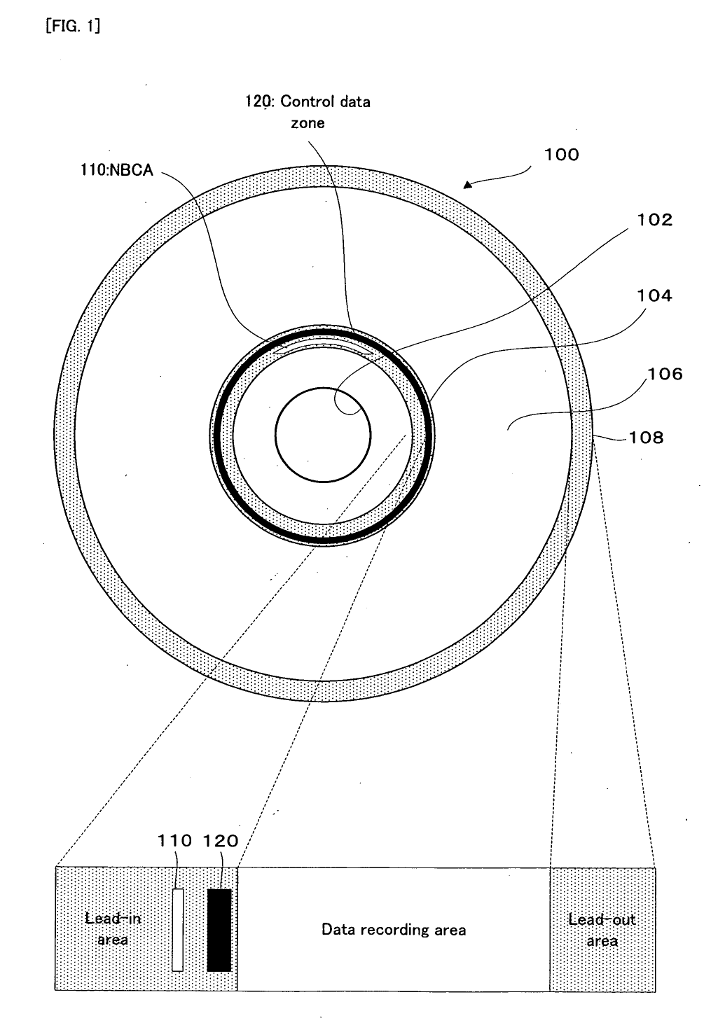

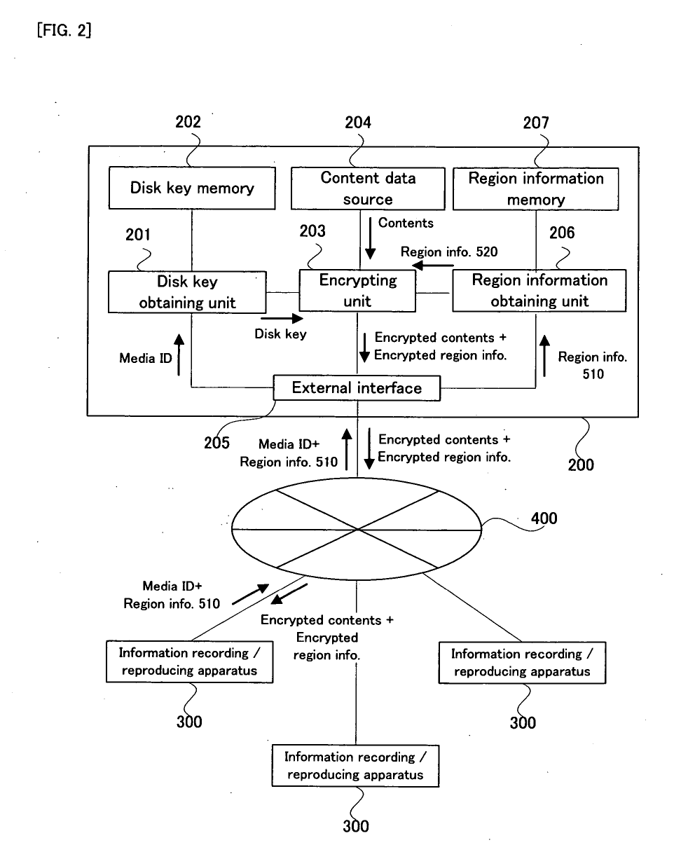

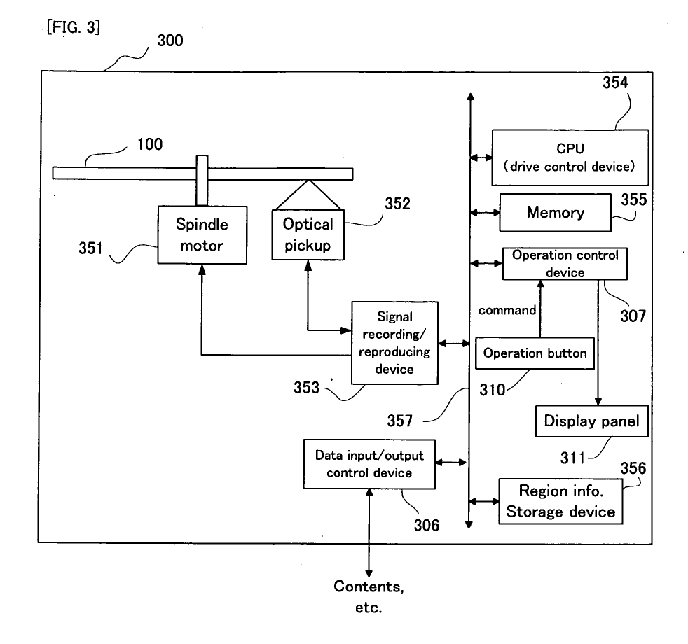

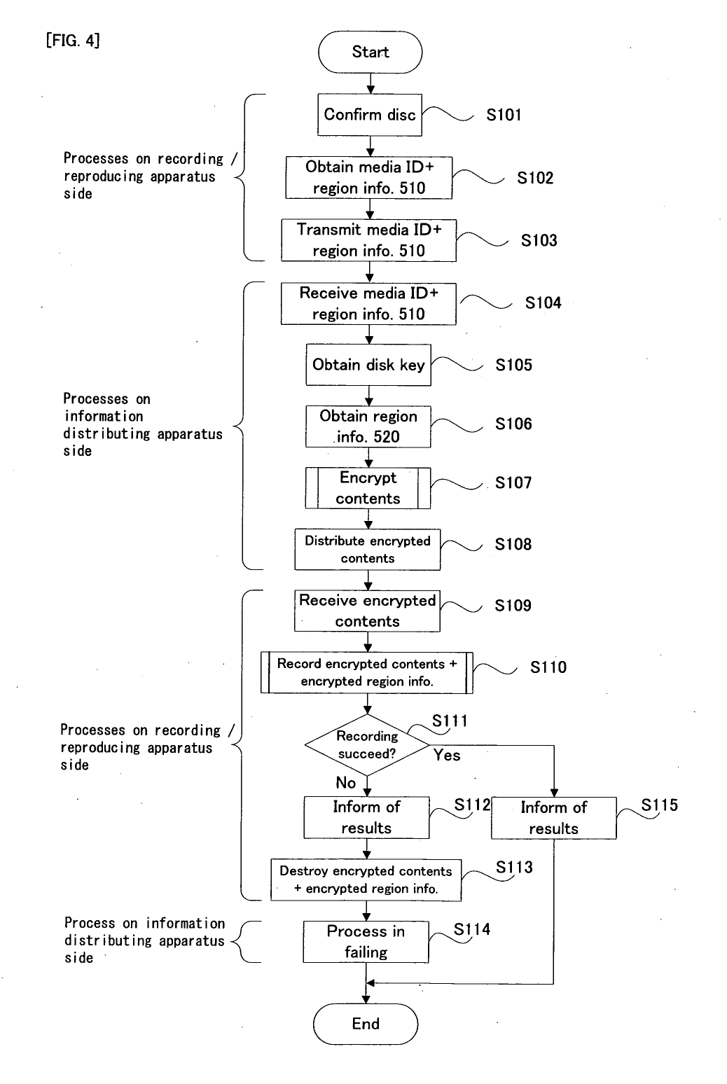

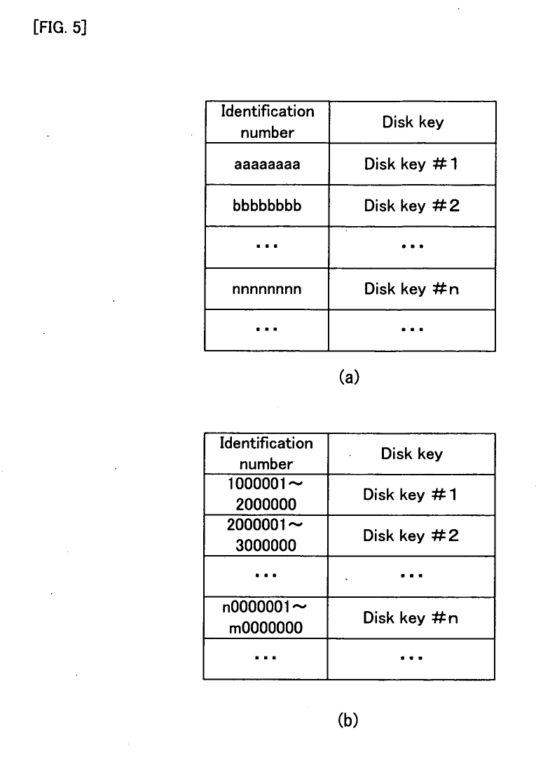

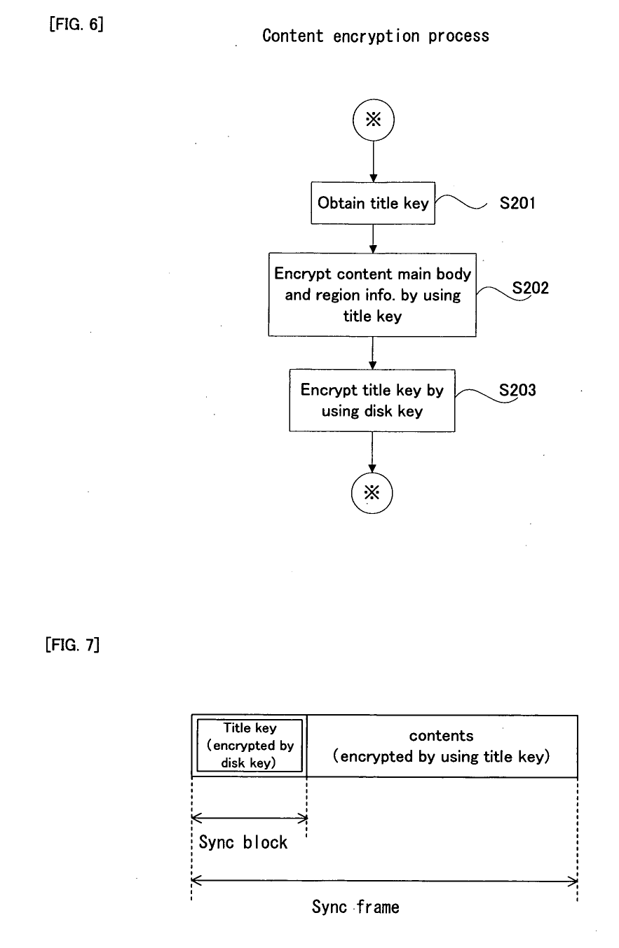

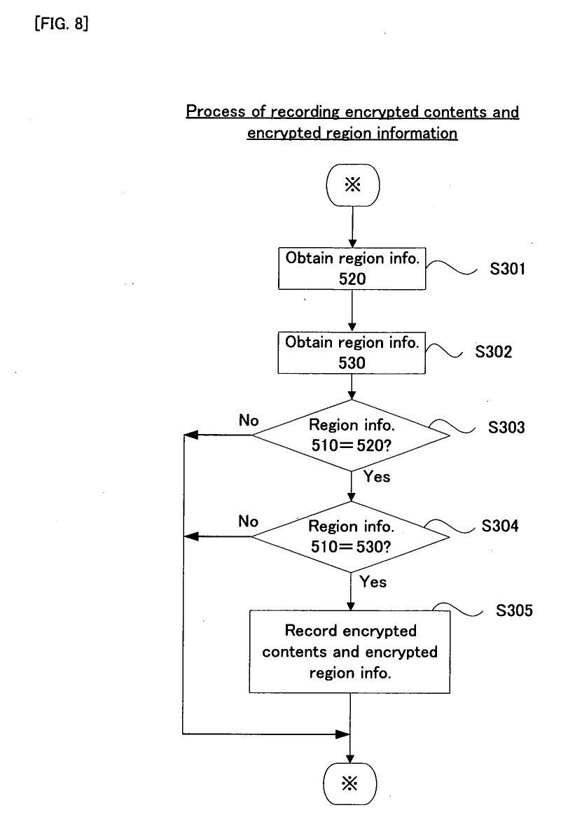

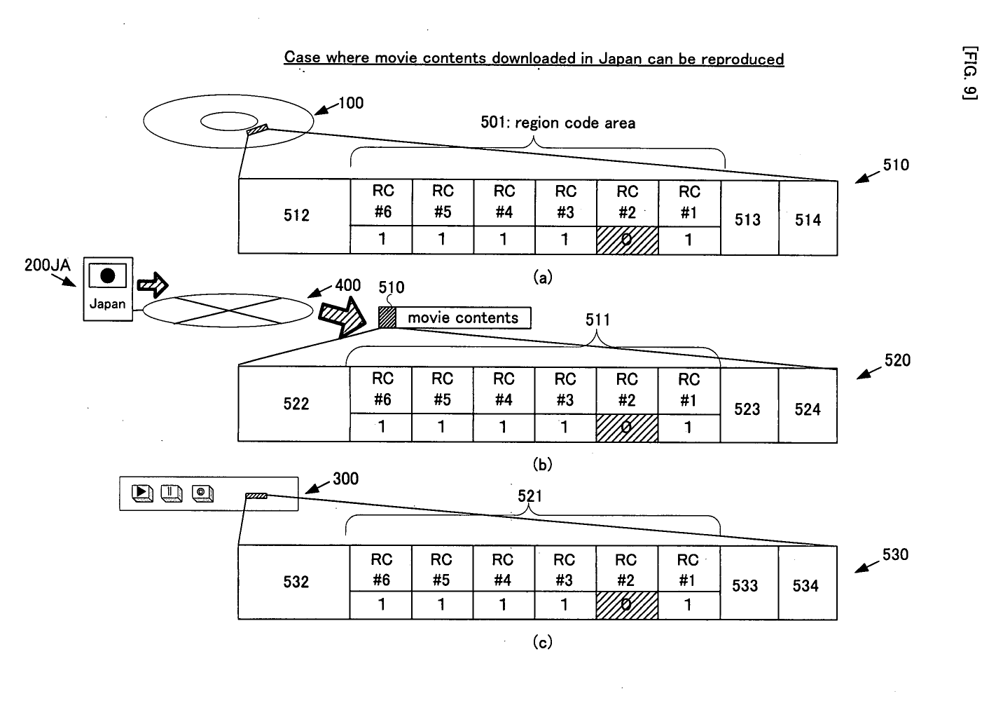

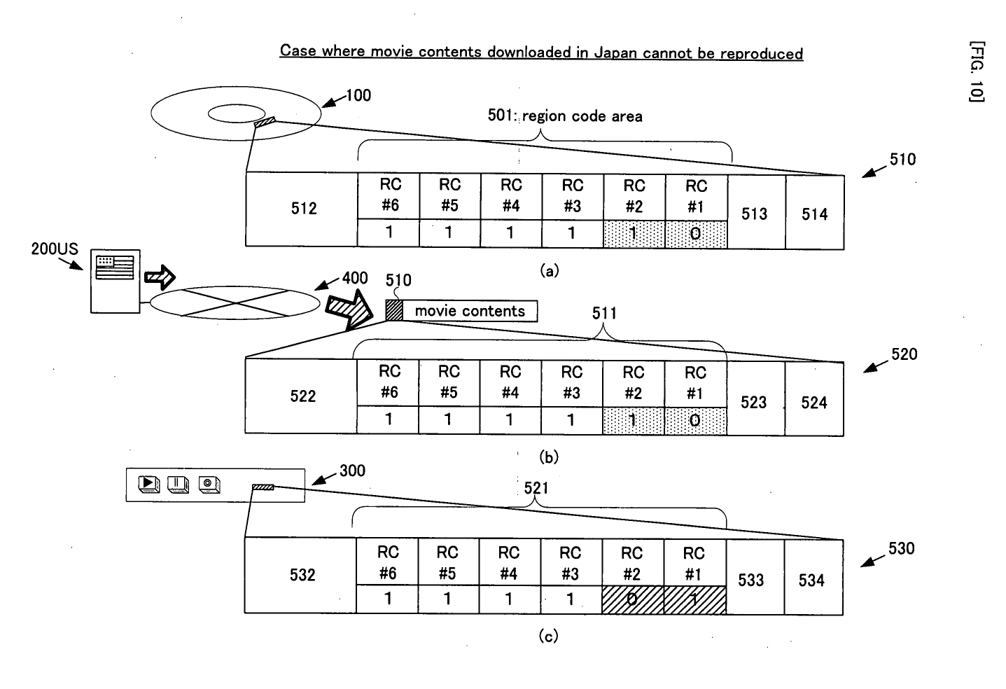

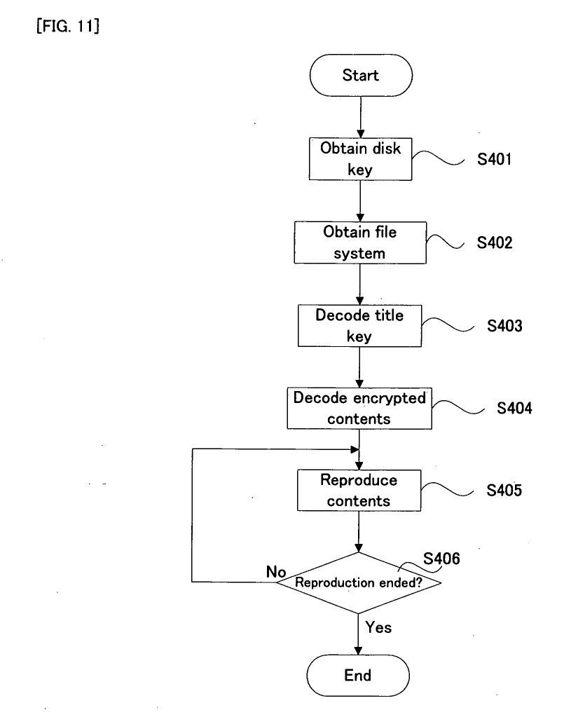

### BRIEF DESCRIPTION OF DRAWINGS

[FIG. 1] FIG. 1 is a plan view conceptually showing the basic structure of an optical disc in an embodiment of the information recording medium of the present invention.

[FIG. 2] FIG. 2 is a block diagram conceptually showing the entire structure of a content distribution system using respective embodiments of the information recording/reproducing apparatus and the information distributing apparatus of the present invention, and the basic structure of the information distributing apparatus in the embodiment.

[FIG. 3] FIG. 3 is a block diagram conceptually showing the basic structure of the information recording/reproducing apparatus in the embodiment.

[FIG. 4] FIG. 4 is a flowchart conceptually showing a flow of respective operations of the information recording/reproducing apparatus and the information distributing apparatus in the embodiment.

[FIG. 5] FIGS. 5 are tables showing specific examples of a correspondence relationship between the media ID and the disk key of the optical disc, recorded on a disk key table provided for the information distributing apparatus in the embodiment.

[FIG. 6] FIG. 6 is a flowchart conceptually showing a flow of the operation related to the encryption of contents, of the information distributing apparatus in the embodiment.

[FIG. 7] FIG. 7 is a data structure diagram conceptually showing the data structure of the contents encrypted by the information distributing apparatus in the embodiment.

[FIG. 8] FIG. 8 is a flowchart conceptually showing a flow of the operation of recording the encrypted contents and encrypted region information in the embodiment.

[FIG. 9] FIGS. 9 are a schematic data structure diagram showing the region information recorded on the optical disc, if the recording or reproduction of contents distributed in Japan is allowed, as one specific example of the distribution system of the present invention (FIG. 9(a)), and a schematic data structure diagram showing the encrypted region information which is distributed with the encrypted contents (FIG. 9(b)), and a schematic data structure diagram showing the region information held by an information recording/reproducing apparatus 300 as attribute information (FIG. 9(c)).

[FIG. 10] FIGS. 10 are a schematic data structure diagram showing the region information recorded on the optical disc, if the recording or reproduction of contents distributed in Japan is not allowed, as another specific example of the distribution system of the present invention (FIG. 10(a)), and a schematic data structure diagram showing the encrypted region information which is distributed with the encrypted contents (FIG. 10(b)), and a schematic data structure diagram showing the region information held by an information recording/reproducing apparatus 300 as the attribute information (FIG. 10(c)).

[FIG. 11] FIG. 11 is a flowchart conceptually showing a flow of the reproduction operation of the encrypted contents, performed by the information recording/reproducing apparatus in the embodiment.

### DESCRIPTION OF REFERENCE CODES

100 optical disc
110 NBCA
120 control data zone
200 information distributing apparatus
201 disk key obtaining unit
202 disk key memory
203 encrypting unit
204 content data source
205 external interface
300 information recording/reproducing apparatus
306 data input/output control device
353 signal recording/reproducing device
354 CPU
400 external network
510 (520, 530) region information

### BEST MODE FOR CARRYING OUT THE INVENTION

Hereinafter, the best mode for carrying out the present invention will be explained in each embodiment in order with reference to the drawings.

Incidentally, in the embodiments, as an encryption method, a method according to the encryption system described in the non-patent document 1 is illustrated and explained as one specific example.

Incidentally, there are a case where region information recorded in a data recording area is encrypted and a case where it is not encrypted. Hereinafter, the case where the region information is encrypted will be explained.

(Information Recording Medium)

Firstly, with reference to FIG. 1, an embodiment of the information recording medium of the present invention will be explained. FIG. 1 is a plan view showing the basic structure of an optical disc 100, which is one specific example of the information recording medium in the embodiment.

As shown in FIG. 1, on the optical disc 100, recording (writing) can be performed a plurality of times or only once in various recording methods, such as a magneto optical method and a phase change method. The optical disc 100 has a recording surface on a disc main body with a diameter of about 12 cm, as is a DVD. On the recording surface, the optical disc 100 is provided with: a center hole 102 as the center; a lead-in area 104; and a data recording area 106; and a lead-out area 108, which is one specific example of the “information recording area” of the present invention, from the inner to the outer circumference. Incidentally, it is obvious that another data which is not encrypted may be recorded into the information recording area. Then, in each area, a groove track and a land track are alternately placed, spirally or concentrically, centered on the center hole 102, for example. The groove track may be wobbled, and pre-pits may be formed on one or both of the tracks out of them. Moreover, the lead-in area 104 and the lead-out area 108 may be pre-recorded in advance. Incidentally, the present invention is not particularly limited to the optical disc having the three recording areas. For example, even if the lead-in area 104 or the lead-out area 108 does not exist, the file structure explained below can be established. Moreover, as described later, the lead-in area 104 and the lead-out area 108 may be further segmentalized. Moreover, the optical disc 100 may be an optical disc with a plurality of recording layers laminated.

In particular, the optical disc 100 has a NBCA 110 (Narrow Band Cutting Area, which is one specific example of the “identification information recording area” of the present invention) in the lead-in area 104, wherein a media ID (or a serial number or the like, which is one specific example of the “identification information” of the present invention) peculiar to the optical disc 100 is recorded in the NBCA 110. The media ID is recorded into the NBCA 110 by irradiating it with laser light in an elliptical beam shape, to thereby cut a barcode-shaped pattern.

Moreover, in the lead-in area 104, there is disposed a control data zone 120 (one specific example of the “encryption key recoding area” of the present invention) in which various control information is recorded, wherein the control information is to control the recording and the reproduction of content data with respect to the optical disc 100. In the control data zone 120, there is recorded a disk key (one specific example of the “encryption key” of the present invention) used for the encryption of contents (content data). The disk key is recorded by embossed pits and a record mark, formed in advance, for example. Moreover, the disk key can be arbitrarily set by an owner of the copyright of the contents which are recorded onto the optical disc 100 and a manufacturer of the optical disc 100 or the like.

Incidentally, the disk key is recorded in the control data zone 120, with the disk key encrypted by a master key provided for an information recording/reproducing apparatus described later. The master key is a key individually allocated to the manufacturer of the information recording/reproducing apparatus or the like. At this time, it is not sure which information recording/reproducing apparatus (specifically, which information recording/reproducing apparatus made by which manufacturer) records or reproduces the contents on the optical disc 100. Thus, a plurality of disk keys (disk key set) encrypted by the master key, which can be allocated to the manufacturer or the like, are preferably recorded in the control data zone 120.

In the control data zone 120, region information 510 (one specific example of the “first region information” of the present invention) is recorded. The region information 510 herein is information indicating allowance or nonallowance of the recording or reproduction of the record information, such as movie content data, for example, in accordance with each region code, wherein the earth is divided into six regions, for example, and the region codes (RC: region identification number) of “#1” to “#6” are allocated to the respective regions. More specifically, as the target of the region information, all the land on earth is divided into six, which are North America, Europe and Japan, Southeast Asia, Oceania and South America, Russia and Africa, and China. Then, in accordance with each region, a data amount of 1 bit is set as information indicating the allowance or nonallowance for the recording or reproduction of the record information. As shown in FIGS. 9 and FIGS. 10, described later, if the flag value of RC (Region Code) “#m” (wherein m=1 to 6) is “0”, the recording or reproduction of the record information, such as content data, is allowed in the relevant region. If the flag value is “1”, the recording or reproduction of the record information is not allowed in the relevant region. Therefore, it is possible to record or reproduce the record information in the plurality of regions on earth, by setting the value of the plurality of RC #m (wherein m=1 to 6) to “0”.

More specifically, the region with RC#1 is English-speaking countries, such as USA and Canada, whose broadcast system is NTSC. The region with RC#2 is Europe, such as England and France, Middle East, such as Jordan, whose broadcast system is PAL, and Japan, whose broadcast is NTSC. The region with RC#3 is Southeast Asia, such as Brunei and Cambodia. The region with RC#4 is Oceania, such as Australia, and South America, such as Mexico and Brazil, and Central and South America, such as Havana. The region with RC#5 is countries in Africa, except for Egypt and South Africa, and countries in the former Soviet Union, such as Russia, and a part of Asia, such as India and Pakistan. The region with RC#6 is China of the communist block.

As described above, the optical disc 100 can impose regional restrictions by using the region information 510 obtained by dividing the world into six regions.

Moreover, the optical disc 100 can realize the regional restrictions without depending on standard television methods adopted by countries, in the region with RC#2 wherein Europe, such as England and France, Middle East, such as Jordan, whose broadcast system is PAL, and Japan, whose broadcast is NTSC are mixed. Moreover, the optical disc 100 can impose the regional restrictions depending on different doctrines and different values by using the region information 510 obtained by dividing the world into six regions, by allocating China of the communist block. Moreover, due to the region code, a supplier of movie contents, such as the Hollywood movie industry, can manage the order of distributing a movie, i.e. the order of releasing a movie in each region. Incidentally, the region information will be explained in detail, in FIGS. 9 and FIGS. 10 describe later.

In the embodiment, the media ID recorded in the NBCA 110 and the region information 510 are transmitted to an information distributing apparatus, and the contents and the region information 510 are encrypted by using the disk key corresponding to the transmitted media ID. Moreover, the encrypted contents and the encrypted region information 510 are distributed to an information recording/reproducing apparatus and recorded into the data recording area 106. Moreover, the information recording/reproducing apparatus decodes the encrypted contents and the encrypted region information 510, on the basis of the disk key recorded in the control data zone 120, to thereby record the contents and the like. These various operations will be described in detail later (refer to FIG. 4 etc.).

(Information Recording Apparatus and Information Distributing Apparatus)

Next, with reference to FIG. 2 to FIG. 11, the embodiments of the information recording apparatus and the information distributing apparatus of the present invention will be explained. Incidentally, in the explanation below, the information recording/reproducing apparatus capable of not only recording the contents but also reproducing the contents will be explained, as one specific example of the information recording apparatus of the present invention.

(1) Basic Structure

Firstly, with reference to FIG. 2 and FIG. 3, an explanation will be given for the basic structure of the information recording/reproducing apparatus and the information distributing apparatus in the embodiment. FIG. 2 is a block diagram conceptually showing the entire structure of a content distribution system using respective embodiments of the information recording/reproducing apparatus and the information distributing apparatus of the present invention, and the basic structure of the information distributing apparatus in the embodiment. FIG. 3 is a block diagram conceptually showing the basic structure of the information recording/reproducing apparatus in the embodiment.

As shown in FIG. 2, an information distributing apparatus 200 and an information recording/reproducing apparatus 300 are connected through a network 400, to thereby form a content distribution system.

As shown in FIG. 2, the information distributing apparatus 200 is provided with: a disk key obtaining unit 201, which is one specific example of the “encryption key obtaining device” of the present invention; a disk key memory 202; an encrypting unit 203, which is one specific example of the “encrypting device” of the present invention; a content data source 204; an external interface 205, which is one specific example of the “first regional information receiving device”, the “identification information receiving device” and the “distributing device” of the present invention; a region information obtaining unit 206; and a region information memory 207.

The disk key obtaining unit 201 is constructed to obtain a desired disk key, on the basis of both the media ID obtained through the external interface 205 and a disk key table stored in the disk key memory 202. For example, the disk key may be generated on the basis of the disk key table stored in the disk key memory 202, or the like. Alternatively, if the disk key itself is stored in advance in the disk key memory 202 in addition to the disk key table, one disk key corresponding to the obtained media ID may be obtained from the disk key memory 202.

The disk key memory 202 stores therein the disk key table or the like indicating an association between the media ID and the disk key. Moreover, the disk key memory 202 may be constructed to store the disk key itself.

The region information obtaining unit 206 is constructed to obtain desired region information 520 (one specific example of the “second regional information” of the present invention) distributed with the record information, such as movie contents, on the basis of both the region information 510 obtained through the external interface 205 and a region information table stored in the region information memory 207.

The region information memory 207 stored therein the above-mentioned region information 520 distributed with the record information. The region information 520 distributed with the record information matches or corresponds to the region information 510 recorded on the optical disc 100. Moreover, the region information memory 207 may be constructed to store a plurality of types of region information itself.

The encrypting unit 203 encrypts various contents outputted from the content data source 204 and the region information 520 outputted from the region information obtaining unit 206, by using the disk key obtained on the disk key obtaining unit 201. As a result, it generates the contents which are encrypted (hereinafter referred to as “encrypted contents”, as occasion demands) and the encrypted region information 520. This encryption process will be described in detail later (refer to FIG. 6 and FIG. 7).

The content data source 204 stores the various contents (e.g. video contents, such as a movie and a TV program, and music contents, etc.) which are recorded onto the optical disc 100. Then, the content data source 204 is constructed to output the stored various contents to the encrypting unit 203. Alternatively, it may be constructed to receive, for example, a program which is broadcasted through the network or through a ground wave and a satellite wave, and to output the received program (i.e. the various contents) to the encrypting unit 203.

The external interface 205 is constructed to output (or transmit) the data from the information distributing apparatus 200 to the exterior, or to obtain (or receive) the data inputted (or transmitted) from the exterior. For example, it is constructed to receive the media ID transmitted from the information recording/reproducing apparatus 300 and to transmit (distribute) the encrypted contents to the information recording/reproducing apparatus 300.

Moreover, the operation of the information distributing apparatus 200 is controlled by a not-illustrated CPU or the like. Namely, the above-mentioned constitutional elements perform the above-mentioned respective various operations, under the control of the CPU.

As shown in FIG. 3, the information recording/reproducing apparatus 300 is provided with: a spindle motor 351; an optical pickup 352; a signal recording/reproducing device 353, which is one specific example of the “recording device” of the present invention; a CPU (drive control device) 354 which is one specific example of the “first comparing device” and the “second comparing device” of the present invention; a memory 355; a region information storage device 356 which stores therein region information 530 which is one specific example of the “third regional information” of the present invention; a data input/output control device 306, which is one specific example of the “transmitting device” and the “receiving device” of the present invention; an operation button 310; a display panel 311; and a bus 357.

The spindle motor 351 is intended to rotate and stop the optical disc 100, and operates upon accessing the optical disc. More specifically, the spindle motor 351 is constructed to rotate and stop the optical disc 100 at a predetermined speed, under spindle servo from a not-illustrated servo unit or the like.

The optical pickup 352 is intended to perform the recording/reproduction with respect to the optical disc 100, and is provided with a laser device, a lens, and the like. More specifically, the optical pickup 352 irradiates the optical disc 100 with a light beam, such as a laser beam, as reading light with a first power upon reproduction, and as writing light with a second power upon recording, with it modulated.

The signal recording/reproducing device 353 controls the spindle motor 351 and the optical pickup 352, to record and reproduce the contents with respect to the optical disc 100.

The memory 355 is used in the general data processing on the information recording/reproducing apparatus 300, including a buffer area for the recording/reproduction data, an area used as an intermediate buffer when the data is converted into the data that can be used on the signal recording/reproducing device 353, and the like. Moreover, the memory 355 is provided with: a ROM area into which a program for performing an operation as the information recording/reproducing apparatus 300 is stored; a buffer used for compression/decompression (or encoding/decoding) of data; a RAM area into which a parameter required for the operation of the program or the like is stored; and the like.

The region information storage device 356 stores therein the region information 530 held by the information recording/reproducing apparatus 300 as attribute information. Namely, the region information 530 is set to indicate the allowance of the recording or reproduction, with respect to the region code of the region in which the information recording/reproducing apparatus 300 is sold. More specifically, as shown in FIG. 9(c) and FIG. 10(c) described later, in the region information 530 held by the information recording/reproducing apparatus 300 sold in Japan, the flag value of RC#2, which is the region code indicating Europe, such as England and France, Middle East, such as Jordan, and Japan, is set to “0” indicating the allowance of the recording or reproduction of the record information, such as content data, in the relevant region.

The CPU (drive control device) 354 is connected to the signal recording/reproducing device 353 and the memory 355 through the bus 357, and controls the entire information recording/reproducing apparatus 300 by giving an instruction to each controlling device. In particular, as explained in FIG. 8 described later, the CPU 354 compares whether or not the three types of region information match; namely, the region information 510 recorded in the control data zone 120 on the optical disc 100, the region information 520 distributed with the record information, such as movie contents, and the region information 530 held by the information recording/reproducing apparatus 300 as the attribute information. On the basis of the comparison result, it determines whether or not the encrypted contents and the encrypted region information can be recorded. Incidentally, software for operating the CPU 354 is stored in the memory 355, for example.

The data input/output control device 306 controls the input/output of the data from the exterior, such as the external network 400, for example, with respect to the information recording/reproducing apparatus 300, to thereby perform storage to and export from the buffer on the memory 355.

The operation control device 307 receives an operation instruction and performs display with respect to the information recording/reproducing apparatus 300, and transmits an instruction by the operation button 310, such as an instruction to record or reproduce, to the CPU 354, and outputs the operation state of the information recording/reproducing apparatus 300, such as during recording and during reproduction, to the display panel 311, such as a fluorescent tube and a liquid crystal panel.

The external network 400 may adopt any of wired and wireless forms, and one portion thereof may be wired and another portion thereof may be wireless. Moreover, it may be a leased line, a public line, a phone line, a packet network, a line switching network, or the like. Moreover, the Internet may be adopted as the external network 400. In any forms, the network line capable of transmitting and receiving the data between the information recording apparatus 300 and the information distributing apparatus 200 may be adopted as the external network 400 in the embodiment.

(2) Explanation of Operation

Next, with reference to FIG. 4, an explanation will be given for the operation principle of the information recording/reproducing apparatus and the information distributing apparatus in the embodiment. FIG. 4 is a flowchart conceptually showing a flow of respective operations of the information recording/reproducing apparatus and the information distributing apparatus in the embodiment.

As shown in FIG. 4, firstly, the optical disc 100 to record thereon the contents is loaded (inserted) on the information recording/reproducing apparatus 300, to thereby perform an initial operation. Specifically, for example, it is checked whether or not the optical disc 100 is an optical disc for content distribution (i.e. for recording the distributed contents) (step S101). If it is not the optical disc for content distribution, the loaded optical disc may be ejected, and an instruction to insert the optical disc for content distribution may be outputted.

In addition, as the initial operation, for example, OPC (Optimum Power Calibration) may be performed to adjust the output power of laser light LB for recording, or strategy may be read to adjust the waveform of the laser light LB for recording, or the like.

Moreover, if the loaded optical disc 100 is an optical disc which is already recorded (or on which the contents cannot be recorded), the recorded optical disc may be ejected, and an instruction to insert a blank optical disc (or an optical disc on which the contents can be recorded) may be outputted.

Then, the NBCA 110 of the loaded optical disc 100 is irradiated with the laser light LB, to thereby read the media ID and the region information 510 recorded in the control data zone 120 (step S102). Then, the read media ID and the read region information 510 are transmitted from the information recording/reproducing apparatus 300 to the information distributing apparatus 200 through the data input/output control device 306, the external network 400, and the external interface 205 (step S103).

At this time, the media ID and the region information 510 may be also further encrypted in accordance with a SSL (Secure Socket Layer) or the like, for example, and outputted to the information distributing apparatus 200. Moreover, various information necessary for the content distribution (e.g. a credit card number for charging a content distribution fee, a title of the contents in which the distribution is desired, etc.) may be transmitted together with the media ID.

Then, the information distributing apparatus 200 receives the media ID (step S104). At this time, for example, if the credit card number is transmitted by the information recording/reproducing apparatus 300, it is preferable to authenticate the credit card number (i.e. get approval from a credit card company). As a result, if the authentication of the credit card number is completed, the operation explained below is preferably performed. Incidentally, a payment process may be actually performed at this point, or the payment process may be performed after receiving whether or not the recording of the encrypted contents succeeds, as described later.

Then, the information distributing apparatus 200 obtains the disk key, by the operation of the disk key obtaining unit 201 (step S105). Specifically, it obtains the disk key corresponding to the received media ID. At this time, the disk key obtaining unit 201 obtains the disk key by using the disk key table or the like stored in the disk key memory 202.

Now, a more detailed explanation will be given for the disk key table or the like stored in the disk key memory 202, with reference to FIGS. 5. FIGS. 5 show specific examples of the disk key table indicating a correspondence relationship between the media ID and the disk key of the optical disc 100, stored in the disk key memory 202.

As shown in FIG. 5(a), it may be a disk key table on which an association between one media ID and its corresponding disk key is described. For example, if a media ID of “aaaaaaaa” is transmitted from the information recording/reproducing apparatus 300, the disk key obtaining unit 201 obtains a disk key #1 as the corresponding disk key. Alternatively, if a media ID of “bbbbbbbb” is transmitted, the disk key obtaining unit 201 obtains a disk key #2 as the corresponding disk key.

Incidentally, the media ID is individually allocated to all the optical disks manufactured in the world. On the other hand, since the disk key has a size of about 40 bits, for example, the number of disk keys is less than that of the media IDs. Thus, in some cases, the same disk key is associated with the different media IDs.

Moreover, as shown in FIG. 5(b), it may be a disk key table on which an association between a series of media IDs in a predetermined range and its corresponding disk key is described. For example, if a media ID of “13423234” is transmitted from the information recording/reproducing apparatus 300, the disk key obtaining unit 201 obtains a disk key #1 as the corresponding disk key. Alternatively, if a media ID of “29999983” is transmitted, the disk key obtaining unit 201 obtains a disk key #2 as the corresponding disk key.

Alternatively, the series of media IDs does not necessarily correspond to one disk key, so that it may be a disk key table on which an association between a group of a plurality of media IDs and one disk key corresponding to the media IDs is described.

It is necessary to prepare such a table in advance, on the basis of the media ID and the type of the disk key recorded on the optical disc having the media ID, along with the manufacturing of the optical disc 100.

Of course, it may be another table other than the above-mentioned ones. In short, it is only necessary for the disk key obtaining unit 201 to recognize the association between N media IDs (wherein N is an integer of 1 or more) and M disk keys (wherein M is an integer of 1 or more). However, the disk key table needs to be severely managed so that a third party cannot easily browse it. Since the disk key table is severely managed as described above, it is possible to increase the confidentiality in the content distribution.

Moreover, it is not limited to the disk key table shown in FIGS. 5, but the disk key may be obtained by using a function in which the input is the media ID and the output is the disk key, for example. This function may be a linear function or a non-linear function, depending on the association between the media ID and the disk key, for example. However, it is preferably a function in which the disk key cannot be easily estimated (i.e. the output cannot be easily estimated from the input).

In FIG. 4 again, the information distributing apparatus 200 obtains the region information 520 by the operation of the region information obtaining unit 206 (step S106). Specifically, it obtains the region information 520 which matches or corresponds to the received region information 510. At this time, the region information obtaining unit 206 obtains the region information 520 by using the region information table stored in the region information memory 207.

Then, the information distributing apparatus 200 encrypts the contents outputted from the content data source 204 and the region information 520 outputted from the region information obtaining unit 206, by using the disk key obtained in the step S105, by the operation of the encrypting unit 203 (step S107). At this time, from the content data source 204, the contents desired by a user of the information recording/reproducing apparatus 300 are outputted, on the basis of a title or the like which is transmitted from the information recording/reproducing apparatus 300, for example. Now, the encryption of the contents will be explained in more detail, with reference to FIG. 6 and FIG. 7. FIG. 6 is a flowchart conceptually showing a flow of the operation related to the encryption of contents. FIG. 7 is a data structure diagram conceptually showing the data structure of the encrypted contents.

As shown in FIG. 6, the encrypting unit 203 firstly obtains a title key (step S201). The title key can be arbitrarily set in accordance with the standard, by an owner of the copyright (or a distributor, etc.) of the contents which are expected to be recorded (i.e. which are expected to be distributed). Therefore, the encrypting unit 203 obtains the set title key. Alternatively, if the title key is set on the information distributing apparatus 200 side, the encrypting unit 203 obtains the title key by setting the title key in accordance with the standard.

Then, by the operation of the encrypting unit 203, the contents and the region information 520 are encrypted by using the title key obtained in the step S201 (step S202). Moreover, by using the disk key, the title key used for the encryption of the contents and the region information 520 is encrypted (step S203). Incidentally, the disk key is not directly used for the encryption of the contents themselves, but used for the encryption of the title key which is used for the encryption of the contents. Thus, it can be said that the disk key is a key used for the encryption of the contents, practically.

At this time, the encrypted contents actually generated (i.e. contents which are encrypted and one specific example of the “encrypted record information” of the present invention) and the encrypted region information actually generated (i.e. region information 520 which is encrypted and one specific example of the “encrypted regional information” of the present invention) include the encrypted title key in a sync block (i.e. a header portion) of a sync frame, and include the encrypted contents and the encrypted region information in a main body portion (i.e. a payload portion) of the sync frame. Alternatively, the title key may be also recorded in the header portion of a sector, which is provided with a plurality of sync frames. The encrypted contents and the encrypted region information having such a sync frame structure are generated in the encryption process, and recorded onto the optical disc 100 by the information recording/reproducing apparatus 300, as explained below.

Namely, the encryption can be set On (execute the process) or Off (does not execute the process) in the sector which is a disc information unit. In this case, the title key may be transmitted in such a format that the contents are added to a sync header, which is the same format as that of the disk key, or may be transmitted separately from content information.

In FIG. 4 again, the information distributing apparatus 200 distributes the encrypted contents and the encrypted region information, encrypted in the step S107, to the information recording/reproducing apparatus 300, through the external interface 205, the external network 400, and the data input/output control device 306 (step S108). At this time, it may also distribute the encrypted contents and the encrypted region information after further encrypting them in accordance with the standard, such as the SSL.

Incidentally, if the encrypted contents and the encrypted region information are not properly recorded on the optical disc 100, the encrypted contents and the encrypted region information cannot be decoded by using the disk key. Thus, in the distribution of the encrypted contents and the encrypted region information, the attributes of the encrypted contents and the encrypted region information (i.e. CCI (Copy Control Information)) may be set to “Never Copy” attributes. Namely, even if the encrypted contents and the encrypted region information are recorded once on a hard disk or the like before recorded onto the optical disc 100, the disk key cannot be obtained from the hard disk, so that originally the encrypted contents and the encrypted region information cannot be reproduced. Thus, even if it is set to the “Never Copy” attribute to distribute the contents, that does not cause any problem.

Moreover, in the encryption process in the step S107, a file system or the like is preferably generated at the same time, to thereby make image data including the file system, the encrypted contents, and the encrypted region information or the like, and then to distribute it to the information recording/reproducing apparatus 300 together with or separately from sector header information.

Then, the information recording/reproducing apparatus 300 receives the distributed encrypted contents and encrypted region information (or the image data) (step S109.

Then, the information recording/reproducing apparatus 300 records the received encrypted contents and encrypted region information onto the optical disc 100 (step S110).

Now, a more detailed explanation will be given for the recording of the received encrypted contents and encrypted region information onto the optical disc 100, performed by the information recording/reproducing apparatus 300, with reference to FIG. 8 to FIGS. 10. FIG. 8 is a flowchart conceptually showing a flow of the operation of recording the encrypted contents and the encrypted region information. FIGS. 9 are a schematic data structure diagram showing the region information recorded on the optical disc, if the recording or reproduction of contents distributed in Japan is allowed, as one specific example of the distribution system of the present invention (FIG. 9(a)), and a schematic data structure diagram showing the encrypted region information which is distributed with the encrypted contents (FIG. 9(b)), and a schematic data structure diagram showing the region information held by the information recording/reproducing apparatus 300 as attribute information (FIG. 9(c)). FIGS. 10 are a schematic data structure diagram showing the region information recorded on the optical disc, if the recording or reproduction of contents distributed in Japan is not allowed, as another specific example of the distribution system of the present invention (FIG. 10(a)), and a schematic data structure diagram showing the encrypted region information which is distributed with the encrypted contents (FIG. 10(b)), and a schematic data structure diagram showing the region information by an information recording/reproducing apparatus 300 as the attribute information (FIG. 10(c)).

As shown in FIG. 8, the information recording/reproducing apparatus 300 firstly decodes the encrypted region information, and obtains the region information 520 (step S301).

Then, the information recording/reproducing apparatus 300 obtains the region information 530 which is stored in the region information storage device 356 and which is held by the information recording/reproducing apparatus 300 as the attribute information (step S302).

Then, the information recording/reproducing apparatus 300 compares the region information 510 recorded in the control data zone 120 on the optical disc 100, which is read in the step S102, and the region information 520 obtained in the step S301, to thereby judge whether or not they match (step S303). If the region information 510 and the region information 520 match (the step S303: Yes), the information recording/reproducing apparatus 300 further compares the above-mentioned region information 510 and the region information 530 obtained in the step S302, to thereby judge whether or not they match (step S304). If the region information 510 and the region information 530 match (the step S304: Yes), the information recording/reproducing apparatus 300 judges that the three types of region information match, and records the encrypted contents and the encrypted region information onto the optical disc 100 (step S305). More specifically, consider such a case that downloading is tried from an information distributing apparatus 200JA for distributing movie contents for Japan, by using the optical disc 100 purchased in Japan and the information recording/reproducing apparatus 300. In this case, the region information 510 recorded on the optical disc, shown in FIG. 9(a), the encrypted region information 520 distributed with the encrypted contents, shown in FIG. 9(b), and the region information 530 held by the information recording/reproducing apparatus 300 as the attribute information, shown in FIG. 9(c) match. Namely, in the region information, the flag value of RC#2, which is the region code indicating Europe, such as England and France, Middle East, such as Jordan, and Japan, is set to “0” indicating the allowance of the recording or reproduction of the record information, such as content data, in the relevant region. By this, the recording or reproduction of the record information, such as movie contents, downloaded in Japan is allowed

Back in the step S305 of FIG. 8 again, in recording the encrypted contents and the encrypted region information onto the optical disc 100, if the image data and the sector header are distributed, the information recording/reproducing apparatus 300 can record the received data onto the optical disc 100 only by performing modulation according to a DVD format or 8-16 modulation or the like. Moreover, if the distributed encrypted contents are encrypted by the SSL or the like, the information recording/reproducing apparatus 300 records them onto the optical disc 100 after decoding them. If the transmitted data is data after DVD modulated in addition to sync sector data, i.e. RAW data, obtained after appending ECC, interleaving it, scrambling it, and performing 8-16 modulation on it, then, the data can be recorded as it is onto the optical disc 100.

More specifically, the recording of the encrypted contents or the like is started from the address of the last recording area of the lead-in area 104 which is not prerecorded, and it is ended at the address of the recording area of the lead-out area 108 which is pre-recorded. If the recording of the encrypted contents and the file system is not performed up to the address of the recording area of the lead-out area 108 which is pre-recorded, buffer data may be recorded up to this address.

On the other hand, as a result of the judgment in the step S303, if the region information 510 and the region information 520 do not match (the step S303: No), and as a result of the judgment in the step S304, if the region information 510 and the region information 530 do not match (the step S304: No), the recording of the encrypted contents and the encrypted region information onto the optical disc 100 in the step S305 is omitted. More specifically, consider such a case that the optical disc 100 is imported from USA to Japan and downloading is tried onto the optical disc 100 from an information distributing apparatus 200UA for distributing movie contents for USA. In this case, with regard to the region information 510 recorded on the optical disc, shown in FIG. 10(a), and the encrypted region information 520 distributed with the encrypted contents, shown in FIG. 10(b), the flag value of RC#1 which is the region code indicating English-speaking countries, such as USA and Canada, is set to “0” indicating the allowance of the recording or reproduction of the record information, such as content data, in the relevant region. However, the information recording/reproducing apparatus, such as a DVD recorder, is purchased in Japan, so that in the region information 530 held by the information recording/reproducing apparatus 300 as the attribute information, shown in FIG. 10(c), the flag value of RC#2, which is the region code indicating Europe, such as England and France, Middle East, such as Jordan, and Japan, is set to “0” indicating the allowance of the recording or reproduction of the record information, such as content data, in the relevant region. By this, all the three types of region information do not match, so that the recording or reproduction of the record information, such as movie contents, downloaded in Japan is not allowed

Now, the details of an area in which the region information is recorded will be explained, with reference to FIGS. 10 in addition to FIG. 9, as occasion demands.

As shown in FIGS. 9 and FIGS. 10, the date of manufacture indicating the manufacturing time of a master disc of ht optical disc 100 as time data may be recorded in an area 512 (522, 532) located before a region code area 501 in which the region code is recorded as at least one portion of the above-mentioned region information.

On the other hand, in a next area 513 (523, 533), the control information about the recording control of the record information may be recorded. As the specific control information from among it, firstly, time allowance condition data may be recorded with a value on a “monthly basis”. In a case where this value is “24”, for example, it may be constructed such that the recording or reproduction of the record information is allowed even if there is an inconsistency between the value of the region code of the region code area 501 and the region code included in the region information 520 decoded from the encrypted region information, which is distributed with the encrypted contents, described later, 2 years (24 months) after the manufacturing of the master disc of the optical disc 100.

In a next area 514 (524, 534), allowance condition data about a user or the information recording/reproducing apparatus may be recorded. More specifically, conditions to allow the recording or reproduction of the record information are recorded only for the particular information recording/reproducing apparatus 300 or the user whose password and ID number matches even if there is an inconsistency in the region information.

In FIG. 4 again, for example, under the control of the CPU 354 of the information recording/reproducing apparatus 300, it is judged whether or not the recording of the encrypted contents and the encrypted region information is normally ended (step S111). Specifically, it is judged whether or not the recording is normally ended, by judging whether or not all the encrypted contents and the encrypted region information are preferably recorded onto the optical disc 100, or whether or not one portion of the encrypted contents and the encrypted region information cannot be received, or the like. If all the encrypted contents and the encrypted region information are preferably recorded onto the optical disc 100, it may be judged that the recording is normally ended. If at least one portion of the encrypted contents and the encrypted region information is not recorded onto the optical disc 100, it may be judged that the recording is not normally ended.

As a result of the judgment, if it is judged that the recording of the encrypted contents and the encrypted region information is normally ended (the step S111: Yes), result information indicating the fact is transmitted to the information distributing apparatus 200, by the operation of the data input/output control device 306, which is one specific example of the “result information transmitting device” of the present invention, under the control of the CPU 354 (step S115), and the recording operation is ended. On the information distributing apparatus 200 side which receives the result information indicating the normal ending, the credit card payment process may be performed, and a user may be actually charged.

On the other hand, if it is judged that the recording of the encrypted contents and the encrypted region information is not normally ended (the step S110: No), result information indicating the fact is transmitted to the information distributing apparatus 200, by the operation of the data input/output control device 306, (step S112). At the same time, if one portion of the encrypted contents and the encrypted region information is recorded on the optical disc 100, the one portion of the encrypted contents and the encrypted region information may be destroyed by overwriting a UDF portion (e.g. the file system, etc.) (step S113). Alternatively, the file system may be not recorded until it is recognized that the recording of the encrypted contents and the encrypted region information is normally ended. In other words, an unusable condition is made so as not to read the one portion of the encrypted contents. By this, it is possible to prevent such a disadvantage that the contents are used although the recording is not normally ended, and it is possible to preferably protect the copyright of the contents.

Moreover, even on the information distributing apparatus 200 side which receives the result information indicating the abnormal ending, a response process in the recording failure is performed (step S114). For example, if the credit card payment process is already performed, a process of paying back the charged amount may be performed, or the encrypted contents and the encrypted region information may be distributed again.

As explained above, by virtue of the content distribution system provided with the information distributing apparatus 200 and the information recording/reproducing apparatus 300, it is possible to properly encrypt the contents, distribute the encrypted contents, and record them onto the optical disc 100.

In the embodiment, particularly, it is not until satisfying such a condition that the region information 510 held by the optical disc 100 matches the region information 520 appended to the record information, such as movie contents, by the information distributing apparatus, that the information recoding apparatus can record or reproduce the record information.

If the region information 510 is not recorded in advance on the record type optical disc, such as a DVD-R/RW, for example, only the encryption system realized by the encryption key is relied on. Thus, in the case of an illegal record type optical disc on which not only the record information, such as movie contents, but also the encryption key are copied by some means, the copyright of the record information is not protected, which allows illegal recording or reproduction.

In contrast, in the embodiment, it is required to satisfy such a condition that the region information 510 recorded in advance on the optical disc 100 matches the region information 520 corresponding to the distributed record information, which is performed by the controlling device or the like of the information recording/reproducing apparatus. Thus, it is possible to further increase the secrecy and confidentiality of the distribution system, to thereby almost or completely prevent the illegal recording or reproduction of the record information.

Moreover, particularly in the embodiment, not the disk key (i.e. information which requires high confidentiality) but the media ID of the optical disc 100 (i.e. information which does not require high confidentiality that much) is transmitted from the information recording/reproducing apparatus 300 to the information distributing apparatus 200. At this time, even if the transmitted media ID is browsed by a malicious third party, the media ID is originally open information, so that the third party cannot recognize the encryption method (e.g. the disk key, etc.) by using this. Therefore, even if the encrypted contents are browsed by the malicious third party at the distribution stage, the third party cannot decode the encrypted contents. If not the medial ID but the disk key, which itself indicates the encryption method, is directly transmitted from the information recording/reproducing apparatus 300 to the information distributing apparatus 200, there is a possibility that the malicious third party obtains the disk key. As a result, there is also considered such a disadvantage that the illegally obtained encrypted contents are decoded. However, in the embodiment, the media ID is transmitted as described above, such a disadvantage can be preferably prevented. Therefore, there is such a great advantage that it is possible to effectively prevent the illegal obtainment, copy or duplication, and reproduction or the like of the contents, to thereby greatly improve (or increase) the confidentiality in the content distribution. In other words, it is possible to distribute the contents under a more secure environment. Moreover, since the confidentiality in the content distribution can be increased, it is possible to properly protect the copyright of the contents.

Incidentally, the flowchart shown in FIG. 4 mixes and shows the operations of the information distributing apparatus 200 and the information recording/reproducing apparatus 300. The step S101 to the step 103, the step S109 to the step 113, and the step S115 are mainly the operation of the information recording/reproducing apparatus 300. The step S104 to the step 108, and the step S114 are mainly the operation of the information distributing apparatus 200.

Next, with reference to FIG. 11, an explanation will be given for a reproduction operation of reproducing the encrypted contents recorded on the optical disc 100, performed by the information recording/reproducing apparatus 300. FIG. 11 is a flowchart conceptually showing a flow of the reproduction operation of reproducing the encrypted contents.

Firstly, as the premise of the reproduction operation, the optical disc 100 is loaded on the information recording/reproducing apparatus 300, and various initial operations are performed. As the various initial operations, the check of the media ID, the check of whether the optical disc 100 is recording media or the like (e.g. whether there is the wobble, etc.), the check of whether or not it is a multilayer type optical disc, the check of whether it adopts a parallel track path or an opposite track path in the case of the multilayer type optical disc, the check of whether or not the recorded contents are encrypted, the check of whether or not it is an optical disc on which the reproduction can be properly performed (i.e. the check of whether or not it is the illegal disc), and the like are performed. As a result of the initial operations, if it is judged to be the optical disc on which the reproduction cannot be properly performed, an indication of the fact may be displayed on a display or the like, and the optical disc may be ejected.

Incidentally, here, the following explanation will be continued under the assumption that the contents recorded in the data recording area 106 are encrypted.

As shown in FIG. 11, firstly, the disk key is obtained (step S401). Specifically, the disk key recorded in the control data zone 120 on the optical disc 100 is read. Then, the file system is obtained (step S402).

Then, the title key is decoded by using the disk key obtained in the step S401 (step S403). Then, the encrypted contents are decoded by using the title key decoded in the step S403 (step S404). By this, it is possible to preferably reproduce the decoded contents (i.e. video images and audio or the like indicating the original contents) (step S405). After that, it is judged whether or not the reproduction is ended (step S406), and if the reproduction is ended, the reproduction operation may be ended, and the optical disc 100 may be ejected.

Incidentally, in the above-mentioned embodiments, the explanation is made by using the encryption system described in the non-patent document 1 as the encryption method; however, of course, another encryption method can adopt the same construction. In short, the information directly used for the encryption, such as the disk key, is not directly exchanged between the information recording/reproducing apparatus and the information distributing apparatus. If the information which can specify the encryption key yet which itself is open information is directly exchanged between the information recording/reproducing apparatus and the information distributing apparatus, it is possible to receive the above-mentioned various benefits.

Moreover, in the above-mentioned embodiments, the disc 100 is explained as one specific example of the information recording medium, and the recorder (player) related to the optical disc 100 is explained as one example of the information recording apparatus. The present invention, however, is not limited to the optical disc and the recorder (player) thereof, and it can be also applied to other various recording media and the recorder (player) thereof.

The present invention is not limited to the above-described embodiments, and various changes may be made, if desired, without departing from the essence or spirit of the invention which can be read from the claims and the entire specification. An information recording medium, an information recording apparatus, an information recording method, an information distributing apparatus, an information distributing method, and a computer program for recording control and for distribution control, which involve such changes, are also intended to be within the technical scope of the present invention.

### INDUSTRIAL APPLICABILITY

The information recording medium, the information recording apparatus and method, the information distributing apparatus and method, and the computer program of the present invention can be applied to an information recording medium, such as a DVD, and information recording apparatus and an information recording method, such as a DVD recorder, and an information distributing apparatus for and an information distributing method of distributing contents to the information recording apparatus or the like. Moreover, they can be applied to an information recording apparatus, an information distributing apparatus or the like, which is mounted on or can be connected to various computer equipment for consumer use or business use, for example.

1-23. (canceled)

24. An information recording medium comprising:
an encryption key recording area in which an encryption key for encrypting record information is recorded in advance;
a regional information recording area in which first regional information is recorded in advance, the first regional information indicating an allowed region in which recording or reproduction of encrypted record information encrypted on the basis of the encryption key, is allowed; and
an information recording area to record therein (i) the encrypted record information, (ii) second regional information indicating an allowed region in which recording or reproduction of the encrypted record information, is allowed and (iii) another encryption key which is encrypted on the encryption key and which encrypts the record information,
the second regional information being encrypted on the basis of the another encryption key and is recorded in the information recording area as encrypted regional information with the encrypted record information and the another encryption key.

25. The information recording medium according to claim 24, further comprising an identification information recording area in which identification information for identifying said information recording medium, is recorded in advance.

26. The information recording medium according to claim 25, wherein the identification information is information peculiar to said information recording medium.

27. An information recording apparatus for recording encrypted record information and a second regional information onto an information recording medium,
said information recording medium comprising:
an encryption key recording area in which an encryption key for encrypting record information is recorded in advance;
a regional information recording area in which first regional information is recorded in advance, the first regional information indicating an allowed region in which recording or reproduction of the encrypted record information encrypted on the basis of the encryption key, is allowed; and
an information recording area to record therein (i) the encrypted record information, (ii) the second regional information indicating an allowed region in which recording or reproduction of the encrypted record information, is allowed and (iii) another encryption key which is encrypted on the encryption key and which encrypts the record information,
the second regional information being encrypted on the basis of the another encryption key and is recorded in the information recording area as encrypted regional information with the encrypted record information and the another encryption key,
said information recording apparatus comprising:
a transmitting device for transmitting the first regional information to an information distributing apparatus for distributing the encrypted record information and the second regional information;
a receiving device for receiving the encrypted record information and the second regional information distributed from said information distributing apparatus; and
a recording device for recording the received encrypted record information and the received second regional information into the information recording area.

28. The information recording apparatus according to claim 27, wherein
said information recording medium further comprises an identification information recording area in which identification information for identifying said information recording medium is recorded in advance,
said transmitting device further transmits the identification information to said information distributing apparatus,
said receiving device receives (i) the encrypted record information encrypted on the basis of the encryption key corresponding to the first regional information and the identification information, and (ii) encrypted regional information obtained by encrypting the second regional information on the basis of the encryption key, and
said recording device records the received encrypted record information and the received encrypted regional information.

29. The information recording apparatus according to claim 28, wherein said transmitting device (i) encrypts at least one of the identification information and the first regional information and (ii) transmits it to said information distributing apparatus.

30. The information recording apparatus according to claim 27, further comprising a first comparing device for comparing (i) an allowed region indicated by the first regional information and (ii) an allowed region indicated by the second regional information,
said recording device recording the received encrypted record information and the received second regional information into the information recording area, if the allowed region indicated by the first regional information and the allowed region indicated by the second regional information match on the basis of a result of the comparison performed by said first comparing device.

31. The information recording apparatus according to claim 27, further comprising a second comparing device for comparing (i) an allowed region indicated by the first regional information, (ii) an allowed region indicated by the second regional information and (iii) an allowed region indicated by third region information held as attribute information by said information recording apparatus,
said recording device recording the received encrypted record information and the received second regional information into the information recording area, if (i-a) the allowed region indicated by the first regional information, (ii-a) the allowed region indicated by the second regional information and (iii-a) the allowed region indicated by the third regional information match on the basis of a result of the comparison performed by said second comparing device.

32. The information recording apparatus according to claim 27, wherein said recording device disables the encrypted record information and the second regional information, if the recording of the encrypted record information and the second regional information into the information recording area does not succeed.

33. The information recording apparatus according to claim 32, wherein said recording device does not record a file system or does not record a correct file system, as a way of the disabling.

34. The information recording apparatus according to claim 32, wherein said recording device overwrites an encrypted information portion, as a way of the disabling.

35. The information recording apparatus according to claim 27, further comprising a result information transmitting device for transmitting result information to said information distributing apparatus, the result information indicating whether or not the recording of the encrypted record information into the information recording area succeeds.

36. An information recording method of recording encrypted record information and a second regional information onto an information recording medium,
said information recording medium comprising:
an encryption key recording area in which an encryption key for encrypting record information is recorded in advance;
a regional information recording area in which first regional information is recorded in advance, the first regional information indicating an allowed region in which recording or reproduction of the encrypted record information encrypted on the basis of the encryption key, is allowed; and
an information recording area to record therein (i) the encrypted record information, (ii) the second regional information indicating an allowed region in which recording or reproduction of the encrypted record information, is allowed and (iii) another encryption key which is encrypted on the encryption key and which encrypts the record information,
the second regional information being encrypted on the basis of the another encryption key and is recorded in the information recording area as encrypted regional information with the encrypted record information and the another encryption key,
said information recording method comprising:
a transmitting process of transmitting the first regional information to an information distributing apparatus for distributing the encrypted record information and the second regional information;
a receiving process of receiving the encrypted record information and the second regional information distributed from said information distributing apparatus; and
a recording process of recording the received encrypted record information and the received second regional information into the information recording area.

37. An information distributing apparatus for distributing a second regional information and encrypted record information to an information recording apparatus,
said information recording apparatus for recording the encrypted record information and the second regional information onto an information recording medium,
said information recording medium comprising:
an encryption key recording area in which an encryption key for encrypting record information is recorded in advance;
a regional information recording area in which first regional information is recorded in advance, the first regional information indicating an allowed region in which recording or reproduction of the encrypted record information encrypted on the basis of the encryption key, is allowed; and
an information recording area to record therein (i) the encrypted record information, (ii) the second regional information indicating an allowed region in which recording or reproduction of the encrypted record information, is allowed and (iii) another encryption key which is encrypted on the encryption key and which encrypts the record information,
the second regional information being encrypted on the basis of the another encryption key and is recorded in the information recording area as encrypted regional information with the encrypted record information and the another encryption key,
said information recording apparatus comprising:
a transmitting device for transmitting the first regional information to an information distributing apparatus for distributing the encrypted record information and the second regional information;
a receiving device for receiving the encrypted record information and the second regional information distributed from said information distributing apparatus; and
a recording device for recording the received encrypted record information and the received second regional information into the information recording area,
said information distributing apparatus comprising:
a first regional information receiving device for receiving the first regional information transmitted from said information recording apparatus;
an encryption key obtaining device for obtaining the encryption key corresponding to the received first regional information;
an encrypting device for (i) encrypting the record information on the basis of the obtained encryption key and (ii) generating the encrypted record information; and
a distributing device for distributing the generated encrypted record information and the second regional information corresponding to the first regional information, to said information recording apparatus.

38. The information distributing apparatus according to claim 37, wherein
said information recording medium further comprises an identification information recording area in which identification information for identifying said information recording medium is recorded in advance,
said information distributing apparatus further comprises an identification information receiving device for receiving the identification information transmitted from said information recording apparatus,
said encryption key obtaining device obtains the encryption key corresponding to the received identification information in addition to or instead of the first regional information,
said encrypting device further encrypts the second regional information as encrypted regional information, on the basis of the obtained encryption key, and
said distributing device further distributes the encrypted regional information.

39. The information distributing apparatus according to claim 38, wherein (i) the encryption key and (ii) at least one of the first regional information and the identification information are associated in a relationship of N vs. M (wherein each of N and M is an integer of 1 or more).

40. The information distributing apparatus according to claim 38, wherein said encryption key obtaining device obtains the encryption key on the basis of at least one of a correspondence table and a function for defying an association between (i) the encryption key and (ii) at least one of the first regional information and the identification information.

41. The information distributing apparatus according to claim 37, wherein attributes of the distributed second regional information and the distributed encrypted record information are “Never Copy” attributes.

42. The information distributing apparatus according to claim 37, wherein said encrypting device (i) encrypts the record information with a predetermined title key and (ii)encrypts the title key with the encryption key, to thereby generate the encrypted record information.

43. An information distributing method of distributing a second regional information and encrypted record information to the information recording apparatus,
said information recording apparatus for recording the encrypted record information and the second regional information onto an information recording medium,
said information recording medium comprising:
an encryption key recording area in which an encryption key for encrypting record information is recorded in advance;
a regional information recording area in which first regional information is recorded in advance, the first regional information indicating an allowed region in which recording or reproduction of the encrypted record information encrypted on the basis of the encryption key, is allowed; and
an information recording area to record therein (i) the encrypted record information, (ii) the second regional information indicating an allowed region in which recording or reproduction of the encrypted record information, is allowed and (iii) another encryption key which is encrypted on the encryption key and which encrypts the record information,
the second regional information being encrypted on the basis of the another encryption key and is recorded in the information recording area as encrypted regional information with the encrypted record information and the another encryption key,
said information recording apparatus comprising:
a transmitting device for transmitting the first regional information to an information distributing apparatus for distributing the encrypted record information and the second regional information;
a receiving device for receiving the encrypted record information and the second regional information distributed from said information distributing apparatus; and
a recording device for recording the received encrypted record information and the received second regional information into the information recording area,
said information distributing method comprising:
a first regional information receiving process of receiving the first regional information transmitted from said information recording apparatus;
an encryption key obtaining process of obtaining the encryption key corresponding to the received first regional information;
an encrypting process of encrypting the record information on the basis of the obtained encryption key and generating the encrypted record information; and
a distributing process of distributing the generated encrypted record information and the second regional information corresponding to the first regional information, to said information recording apparatus.

44. A computer program of instructions for recording control and for tangibly embodying a program of instructions executable by a computer provided in an information recording apparatus, to make the computer function as at least one portion of a transmitting device, a receiving device, and a recording device
said information recording apparatus for recording encrypted record information and a second regional information onto an information recording medium,
said information recording medium comprising:
an encryption key recording area in which an encryption key for encrypting record information is recorded in advance;
a regional information recording area in which first regional information is recorded in advance, the first regional information indicating an allowed region in which recording or reproduction of the encrypted record information encrypted on the basis of the encryption key, is allowed; and
an information recording area to record therein (i) the encrypted record information, (ii) the second regional information indicating an allowed region in which recording or reproduction of the encrypted record information, is allowed and (iii) another encryption key which is encrypted on the encryption key and which encrypts the record information,
the second regional information being encrypted on the basis of the another encryption key and is recorded in the information recording area as encrypted regional information with the encrypted record information and the another encryption key,
said information recording apparatus comprising:
said transmitting device for transmitting the first regional information to an information distributing apparatus for distributing the encrypted record information and the second regional information;
said receiving device for receiving the encrypted record information and the second regional information distributed from said information distributing apparatus; and
said recording device for recording the received encrypted record information and the received second regional information into the information recording area.

45. A computer program of instructions for distribution control and for tangibly embodying a program of instructions executable by a computer provided in the information distributing apparatus, to make the computer function as at least one portion of a first regional information receiving device, an encryption key obtaining device, an encrypting device, and a distributing device,
said information distributing apparatus for distributing a second regional information and encrypted record information to an information recording apparatus,
said information recording apparatus for recording the encrypted record information and the second regional information onto an information recording medium,
said information recording medium comprising:
an encryption key recording area in which an encryption key for encrypting record information is recorded in advance;
a regional information recording area in which first regional information is recorded in advance, the first regional information indicating an allowed region in which recording or reproduction of the encrypted record information encrypted on the basis of the encryption key, is allowed; and
an information recording area to record therein (i) the encrypted record information, (ii) the second regional information indicating an allowed region in which recording or reproduction of the encrypted record information, is allowed and (iii) another encryption key which is encrypted on the encryption key and which encrypts the record information,
the second regional information being encrypted on the basis of the another encryption key and is recorded in the information recording area as encrypted regional information with the encrypted record information and the another encryption key,
said information recording apparatus comprising:
a transmitting device for transmitting the first regional information to an information distributing apparatus for distributing the encrypted record information and the second regional information;
a receiving device for receiving the encrypted record information and the second regional information distributed from said information distributing apparatus; and
a recording device for recording the received encrypted record information and the received second regional information into the information recording area,
said information distributing apparatus comprising:
said first regional information receiving device for receiving the first regional information transmitted from said information recording apparatus;
said encryption key obtaining device for obtaining the encryption key corresponding to the received first regional information;
said encrypting device for (i) encrypting the record information on the basis of the obtained encryption key and (ii) generating the encrypted record information; and
said distributing device for distributing the generated encrypted record information and the second regional information corresponding to the first regional information, to said information recording apparatus.

46. The information recording medium according to claim 24, wherein in the information recording area,
the another encryption key is recorded in a sync block of a sync frame, and
the encrypted regional information is recorded in a main body portion of the sync frame.
